(19) United States
(12) Patent Application Publication
(10) Pub. No.: US 2004/0029455 A1
(43) Pub. Date: Feb. 12, 2004

(54) Connector and method for forming a connection with an electrical cable

(76) Inventors: Barry Johnson, Ontario (CA); Peter Donovan, Aurora (CA); Peter Chan, Toronto (CA)

Correspondence Address: Tyco Electronics Corporation, Intellectual Property Law Department, M/S R20/2B, 307 Constitution Drive, Menlo Park, CA, 94026-1164, US

(21) Appl. No.: 10/217,134

(22) Filed: Aug. 12, 2002

(51) Int. Cl. H01R 11/09

(52) U.S. Cl. 439/796

(57) ABSTRACT

A connector for forming a connection with at least one electrically conductive cable using a mechanical tool having an engagement portion includes a tubular shell having a connector axis and defining a receiving opening and an interior cavity communicating with the receiving opening. The receiving opening is adapted to receive the cable. The interior cavity tapers inwardly along the connector axis toward the receiving opening. A jaw member is disposed in the shell and is adapted to grip the cable when the cable is disposed in the interior cavity and the jaw member is driven along the connector axis toward the receiving opening. The connector is adapted to removably receive at least the engagement portion of the tool such that the tool may be used to forcibly drive the jaw member along the connector axis to grip the cable, the jaw member being configured to retain its grip on the cable upon removal of the engagement portion from the connector.

### FIELD OF THE INVENTION

The present invention relates to methods and devices for securing a cable and, more particularly, to connectors and methods for forming a connection with an electrical cable.

### BACKGROUND OF THE INVENTION

Large diameter high voltage cables often must be terminated or joined (spliced) in various environments, such as underground or overhead. Such cables may be, for example, high voltage electrical distribution or transmission lines.

Methods and devices have been proposed and implemented for terminating and joining such cables. According to certain designs, a cable is terminated or joined to another cable by a connector having a pair of opposed gripping jaws. The jaws may be disposed in a tapered housing. The jaws are locked onto the cable by forcing the jaws into the narrowing taper of the housing such that the jaws converge tightly onto the end of the cable. According to other designs, the jaws are forced into the locking position by detonating a propellant within the housing. According to yet further designs, the jaws are pulled into the locking position by pulling on the cable. These and other methods and devices may suffer from significant drawbacks with regard to cost, complexity, reliability and/or ease of use, particularly in the field.

### SUMMARY OF THE INVENTION

According to embodiments of the present invention, a connector for forming a connection with at least one electrically conductive cable using a mechanical tool having an engagement portion includes a tubular shell having a connector axis and defining a receiving opening and an interior cavity communicating with the receiving opening. The receiving opening is adapted to receive the cable. The interior cavity tapers inwardly along the connector axis toward the receiving opening. A jaw member is disposed in the shell and is adapted to grip the cable when the cable is disposed in the interior cavity and the jaw member is driven along the connector axis toward the receiving opening. The connector is adapted to removably receive at least the engagement portion of the tool, such that the tool may be used to forcibly drive the jaw member along the connector axis to grip the cable. The jaw member is configured to retain its grip on the cable upon removal of the engagement portion of the tool from the connector.

According to further embodiments of the present invention, a system for forming a connection with at least one electrically conductive cable includes a mechanical tool having an engagement portion. A connector is provided including a tubular shell having a connector axis and defining a receiving opening and an interior cavity communicating with the receiving opening, the receiving opening being adapted to receive the cable. The interior cavity tapers inwardly along the connector axis toward the receiving opening. A jaw member is disposed in the shell and is adapted to grip the cable when the cable is disposed in the interior cavity and the jaw member is driven along the connector axis toward the receiving opening. The connector is adapted to removably receive at least the engagement portion of the tool such that the tool may be used to forcibly drive the jaw member along the connector axis to grip the cable. The jaw member is configured to retain its grip on the cable upon removal of the engagement portion of the tool from the connector.

According to method embodiments of the present invention, a method is provided for forming a connection including a connector and a cable. The connector includes a tubular shell having a connector axis and defining a receiving opening and an interior cavity communicating with the receiving opening. The interior cavity tapers inwardly along the connector axis toward the receiving opening. The connector further includes a jaw member disposed in the shell. The cable is inserted through the receiving opening and into the interior cavity. An engagement portion of a mechanical tool is inserted into the connector. The tool is used via the engagement portion to drive the jaw member along the connector axis toward the receiving opening, such that the jaw member grips the cable. Thereafter, the engagement portion of the tool is removed from the connector.

According to further embodiments of the present invention, a connector for forming a connection with at least one electrically conductive cable using a mechanical tool includes a tubular shell including a side wall and having a connector axis. The shell defines a wedge slot in the side wall, a receiving opening adapted to receive the cable, and an interior cavity communicating with the receiving opening. The interior cavity is adapted to receive an end portion of the cable such that the end portion extends along the connector axis. A jaw member is disposed in the shell and is adapted to grip the end portion in the interior cavity. The connector includes a wedge member adapted to be inserted through the wedge slot and into the interior cavity between the jaw member and the side wall to force the jaw member radially into engagement with the end portion.

According to further embodiments of the present invention, a system for forming a connection with at least one electrically conductive cable includes a connector including a tubular shell including a side wall and having a connector axis. The shell defines a wedge slot in the side wall, a receiving opening adapted to receive the cable, and an interior cavity communicating with the receiving opening. The interior cavity is adapted to receive an end portion of the cable such that the end portion extends along the connector axis. A jaw member is disposed in the shell and is adapted to grip the end portion in the interior cavity. The connector includes a wedge member adapted to be inserted through the wedge slot and into the interior cavity between the jaw member and the side wall to force the jaw member radially into engagement with the end portion. A mechanical tool is adapted to forcibly drive the wedge member into the interior cavity between the jaw member and the side wall.

According to further method embodiments of the present invention, a method for forming a connection including a connector and a cable is provided. The connector includes a tubular shell and a jaw member disposed in the shell, the shell including a side wall and having a connector axis. The shell defines a wedge slot in the side wall, a receiving opening, and an interior cavity communicating with the receiving opening. An end portion of the cable is inserted through the receiving opening and into the interior cavity. A wedge member is inserted through the wedge slot and into the interior cavity between the jaw member and the side wall to force the jaw member radially into engagement with the end portion.

Objects of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

FIG. 1 is a perspective view of a connector system according to embodiments of the present invention;

FIG. 2 is a cross-sectional view of the system of FIG. 1 taken along the line 2-2 of FIG. 1;

FIG. 3 is a cross-sectional view of the system of FIG. 1 taken along the line 3-3 of FIG. 2, wherein the system is in a ready position;

FIG. 4 is a cross-sectional view of the system of FIG. 1, wherein the system is in an installed position;

FIG. 5 is a cross-sectional view of a splice connection formed using the system of FIG. 1;

FIG. 6 is an exploded, perspective view of a connector forming a part of the system of FIG. 1;

FIG. 7 is a partial perspective view of a connector system according to further embodiments of the present invention;

FIG. 8 is a partial, cross-sectional view of the system of FIG. 7 taken along the line 8-8 of FIG. 7;

FIG. 9 is a cross-sectional view of the system of FIG. 7 taken along the line 9-9 of FIG. 8, wherein the system is in a ready position;

FIG. 10 is a partial, cross-sectional view of the system of FIG. 7 wherein the system is in an installed position;

FIG. 11 is an exploded, perspective view of a connector forming a part of the system of FIG. 7,

FIG. 12 is a cross-sectional view of a connector system according to further embodiments of the present invention, wherein the system is in an installed position;

FIG. 13 is a cross-sectional view of a connector system according to further embodiments of the present invention wherein the system is in a partially installed position;

FIG. 14 is a partial cross-sectional view of a connector system according to further embodiments of the present invention;

FIG. 15 is a cross-sectional view of the system of FIG. 13 taken along the line 15-15 of FIG. 14; and

FIG. 16 is a cross-sectional view of a splice connection formed using the system of FIG. 14.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the relative sizes of regions may be exaggerated for clarity. It will be understood that when an element such as a component, layer, region or substrate is referred to as being “on” or “connected to” another element, it can be directly on or connected to the other element or intervening elements may also be present. In contrast, when an element is referred to as being “directly on” or “directly connected to” another element, there are no intervening elements present.

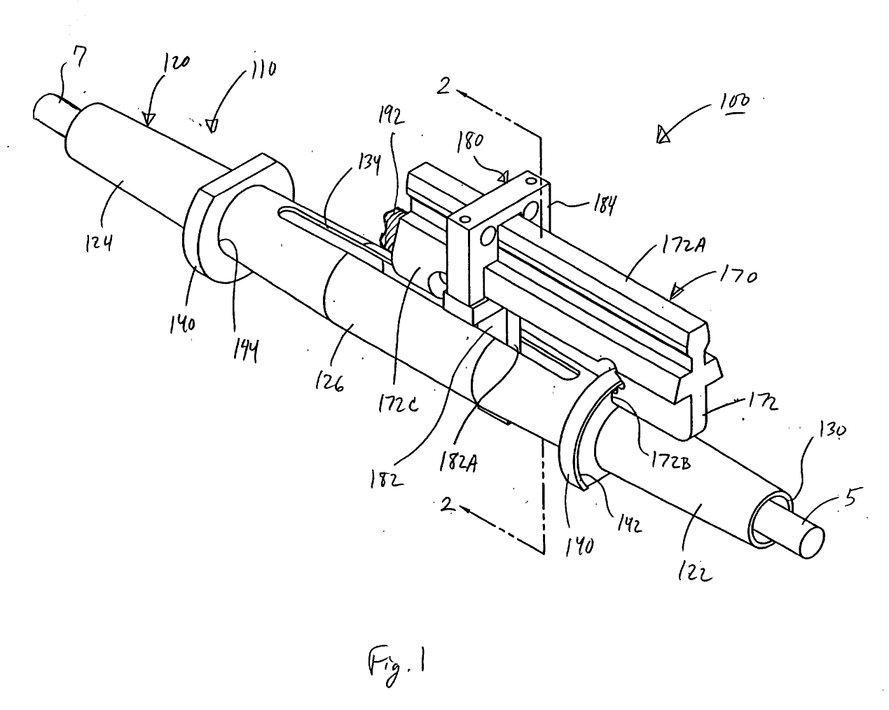

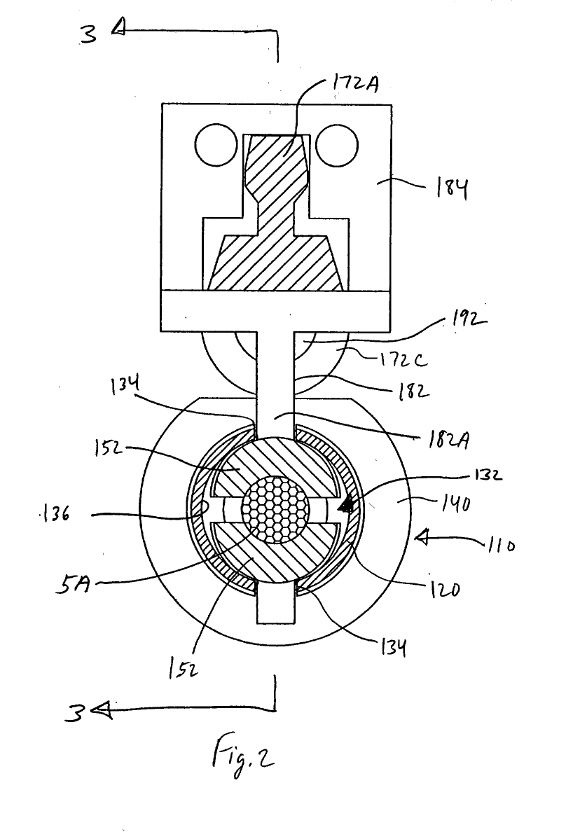

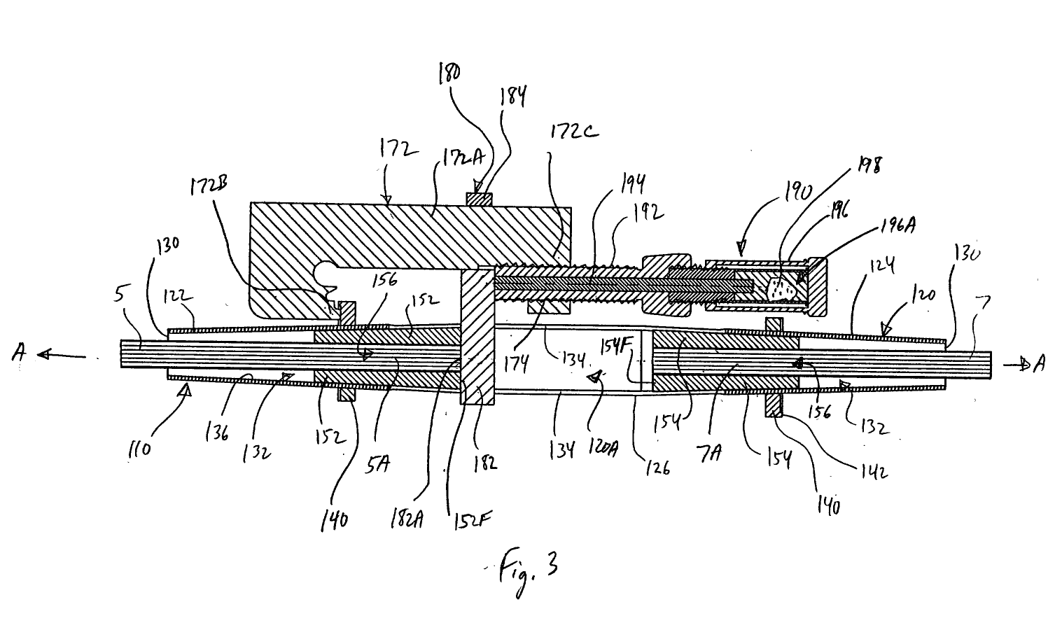

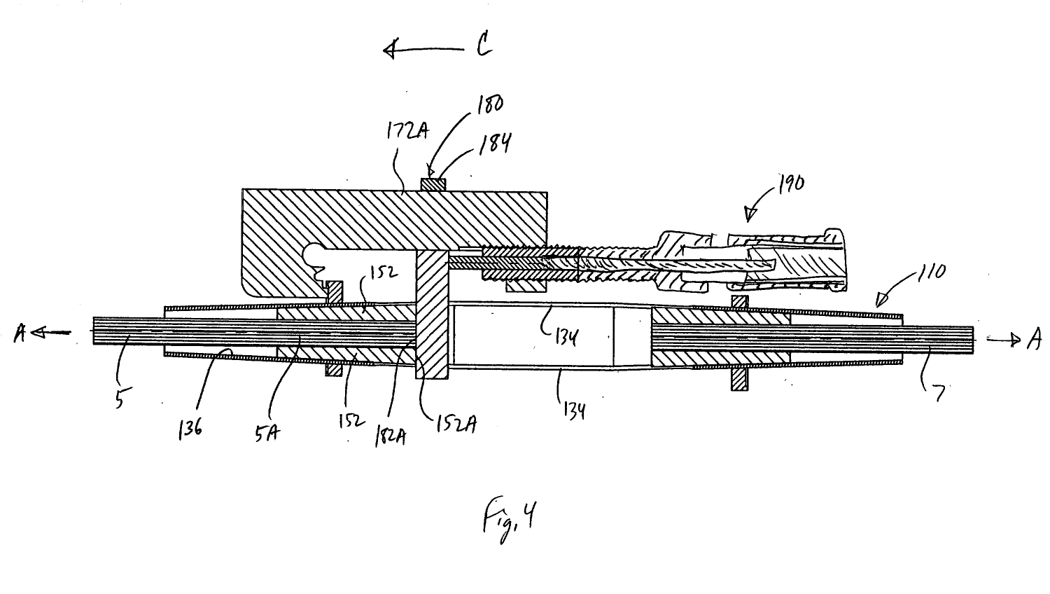

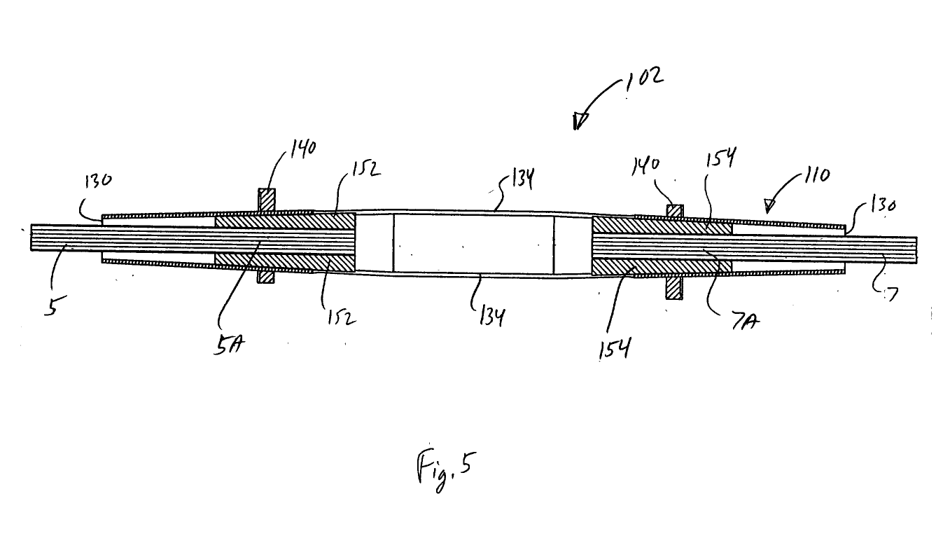

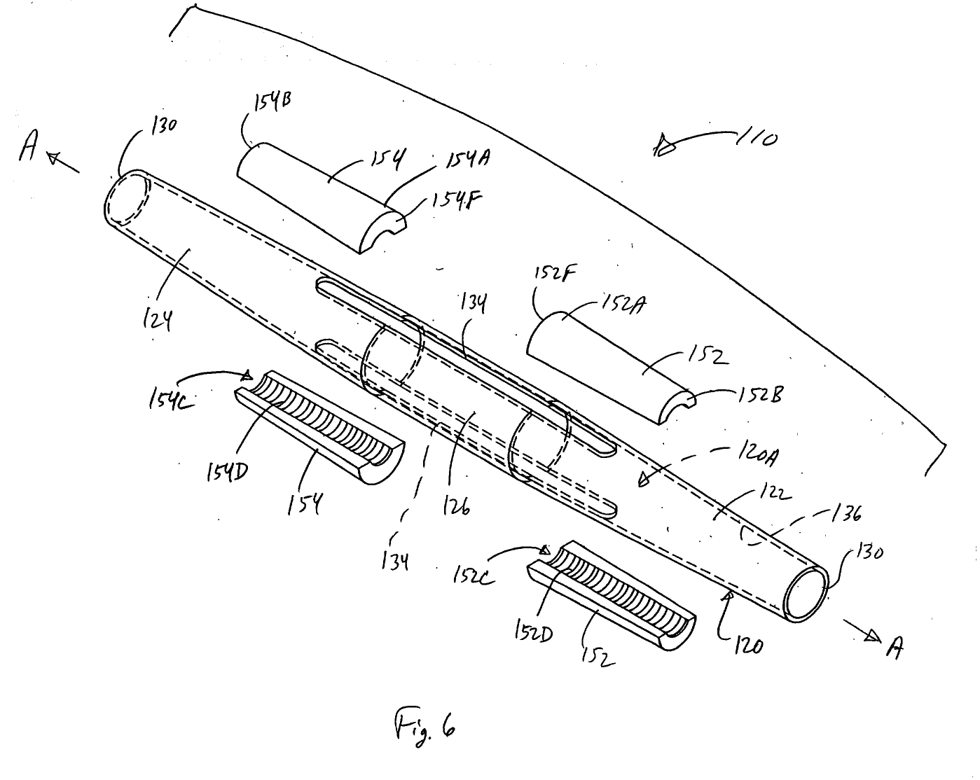

With reference to FIGS. 1-4, a connector system 100 according to embodiments of the present invention will now be described. The system 100 includes a connector 110 (FIG. 6), an application tool 170 and a force generator or driver 190 (FIGS. 3 and 4). The application tool 170 and driver 190 may be used to secure the connector 110 onto the cables 5, 7 (see FIG. 5).

The system 100 may be used to form a connection such as an inline cable splice 102 as shown in FIG. 5. The splice 102 includes electrically conductive cables 5 and 7 mechanically and electrically connected by the connector 110. The cables 5, 7 may be, for example, electrically conductive metal cables as commonly used for power transmission and distribution lines. The cables 5, 7 may include, for example, twisted strands with or without a core cable surrounded by the strands. According to certain preferred embodiments, the system 100 and the connector 110 are adapted for use with cables 5, 7 having a nominal diameter in the range of from about 0.10 to 2.0 inches.

As best seen in FIG. 6, the connector 110 includes a shell 120. The shell 120 has an inner surface 136 defining a passage 120A extending fully therethrough and communicating with opposed receiving openings 130. The shell 120 includes opposed portions 122 and 124 each defining a respective tapered interior cavity 132 (FIG. 3) forming a part of the connector passage 120A. The shell 120 also includes an intermediate portion 126 joining the portions 122, 124. The connector 110 has a connector axis A-A extending longitudinally through the passage 120A. A pair of opposed, axially extending slots 134 are formed in the shell 120 and communicate with the passage 120A. The interior cavities 132 within the shell portions 122 and 124 are each tapered such that they converge in the direction of the respective receiving openings 130.

Preferably, the interior cavities are truncated conical in shape as illustrated. Preferably, the passage 120A has a generally fusiform shape as illustrated. Preferably, the wall thickness of the shell 120 is substantially uniform along its length so that the outer profile of the shell 120 is likewise fusiform.

Preferably, the wall thickness of the shell 120 is between about 0.06 and 0.375 inch. The diameter of the receiving openings 130 is preferably between about 0.5 and 2.5 inches. The axial length of the shell 120 is preferably between about 10 and 36 inches.

The shell 120 may be formed by any suitable means and methods. For example, the shell 120 may be formed by extrusion, seamless extrusion, or drawing. The shell 120 may be tapered by, for example, spinning, rotary swaging or other swaging. The shell 120 is formed of an electrically conductive material, preferably metal. The shell 120 is preferably formed of aluminum alloy or copper alloy. More preferably, the shell 120 is formed of aluminum alloy.

A pair of jaw members 152 are disposed in the cavity 132 of the shell portion 122 and a pair of jaw members 154 are disposed in the cavity 132 of the shell portion 124. Each of the jaw members 152 tapers inwardly from an inner end 152A to an outer end 152B adjacent the respective receiving opening 130. Similarly, each jaw member 154 tapers inwardly from an inner end 154A to an outer end 154B adjacent the respective receiving opening 130. Preferably, the tapers of the outer surfaces of the jaw members 152, 154 are complementary to the tapers of the inner surface 136 of the shell 120 in the shell portions 122, 124. Preferably, the inner surface 136 of the shell portions 122, 124 and the jaw members 152, 154 taper at an angle of between about 1.5 and 6 degrees relative to the connector axis A-A. Each of the jaw members 152 has a strike surface 152F and a serrated surface 152D defining an axially extending channel 152C. Similarly, each of the jaw members 154 has a strike surface 154F and a serrated surface 154D defining an axially extending channel 154C.

The jaw members 152, 154 may be formed by any suitable means or method. The jaw members 152, 154 are formed of an electrically conductive material, preferably metal. The jaw members 152, 154 are preferably formed of aluminum alloy or copper alloy. More preferably, the jaw members 152, 154 are formed of aluminum alloy.

As best seen in FIG. 1, a pair of flange members 140 are mounted on each of the shell portions 122 and 124. Each flange member has an opening 144 through which the respective shell portion 122, 124 is received. Each flange member 140 extends radially outwardly (with respect to the connector axis A-A) from the shell 120. Each flange member 140 has an upstanding, axially and circumferentially extending flange or lip 142. The flanges 140 may be secured to the shell 120 by, for example, welding, adhesive, press fitting or integral formation (e.g., stamping or casting). Alternatively, the flange members 140 may be temporarily mounted on the shell 120 by sliding the flange members 140 toward the intermediate shell section 126 until the enlarging diameters of the tapered shell portions 122, 124 limit movement of the flange members 140. The flange members 140 may be formed of aluminum alloy, copper alloy or plastic.

With reference to FIGS. 1-3, the application tool 170 includes a body 172. The body 172 includes a rail 172A, an abutment portion 172B and a driver mount portion 172C. The abutment portion 172B is preferably hook-shaped as illustrated or v-shaped. A threaded bore 174 is formed in the driver mount portion 172C. The body 172 is preferably formed of metal. More preferably, the body 172 is formed of forged steel or machined tool steel. Preferably, the body 172 is unitarily formed or assembled.

A shuttle 180 is mounted on the body 172. The shuttle 180 includes a yoke 184 adapted to slide along the rail 172A. The shuttle 180 further includes an engagement arm 182 secured to and depending from the yoke 184. The engagement arm 182 has an engagement surface 182A. The yoke 184 and the engagement arm 182 are preferably formed of metal. More preferably, the yoke 184 and the engagement arm 182 are formed of forged steel or machined tool steel.

With reference to FIGS. 3 and 4, the driver 190 includes an externally threaded barrel 192. A driver body 196 is removably (for example, threadedly) joined to the barrel 192 and defines a chamber 196A. An explodable propellant 198 is disposed in the chamber 196A. A piston 194 extends from the chamber 196A and through the barrel 192. Ends of the barrel 192 and the piston 194 are positioned adjacent the engagement arm 182 opposite the engagement surface 182A. The driver 190 is configured such that force from explosion of propellant 198 will drive the piston 194 outwardly from the body 196 and toward the engagement arm 182.

The components of the driver 190 may be formed of any suitable materials. The propellant 198 may be, for example, gunpowder. Suitable drivers 190 include the AMPACT™ tool, available from Amp Incorporated. Other forced generator means may be used in place of the driver 190, as discussed below in more detail.

The system 100 may be used to form the splice 102 or other desired connection using the following method in accordance with method embodiments of the present invention. The cable 5 is inserted into the portion 122 through the adjacent receiving opening 130 such that it is received in a passage 156 defined between the jaw members 152 as shown in FIG. 3.

Before or after inserting the cable 5, the tool 170 is mounted on the connector 110 such that the abutment portion 172B engages the flange member 140 and the engagement member 182 extends through each of the slots 134 and the connector passage 120A. See FIGS. 1-3. The lip 142 helps to securely seat and retain the hook-shaped abutment portion 172B. The engagement surface 182A is positioned facing, and preferably in contact with, the strike surfaces 152F of the jaw members 152. The tool 170 and the connector 110 are thereby placed in a ready position.

Before or after mounting the tool 170 on the connector 110, the driver 190 is installed in the tool 170 by screwing the barrel 192 into the bore 174. The driver 190 is loaded with the propellant 198 before or after installing the driver 190 on the tool 170.

Thereafter, the driver 190 is fired (i.e., the propellant 198 is discharged) in suitable manner. For example, the driver 190 may be fired by igniting the propellant 198 with an electronic fuse or striking the end of the driver body 196 with an AMPACT cartridge installed in the chamber 196A. When the driver 190 is fired, the piston 194 is driven in the direction C (FIG. 4). The piston 194 drives the engagement arm 182 in the direction C, which in turn drives the jaw members 152 and the cable 5 along the connector axis A-A in the direction C relative to the shell 120 to a locked position. Because the interior cavity 132 of the shell portion 122 is tapered, the inner surface 136 forces the jaw members 152 radially toward one another such that they are tightly compressed onto a portion 5A of the cable 5. In this manner, the cable 5 is substantially permanently secured to the connector 110 by an interference fit between the jaw members 152 and the inner surface 136 of the shell 120.

With the system 100 in the locked position, the tool 170 and the driver 190 are thereafter removed from the connector 110, rotated 180 degrees relative to the connector 110 and reinstalled on the connector 110 to secure the cable 7. More particularly, the engagement arm 182 is again inserted through the slots 134 and the passage 120A and the engagement surface 182A is positioned adjacent and facing the strike surfaces 154F of the jaw members 154. The abutment portion 172B is placed in abutment with the other flange member 140. The driver 190 is reloaded with propellant or AMPACT cartridge as needed and again fired to force the jaw members 154 down the shell portion 124 toward the adjacent receiving opening 130. In this manner, a portion 7A of the cable 7 is secured within the connector 110.

The tool 170 and the driver 190 are thereafter again removed from the connector such that only the splice 102 as shown in FIG. 5 remains. If desired and provided for, the flange members 140 may also be removed from the connector 110.

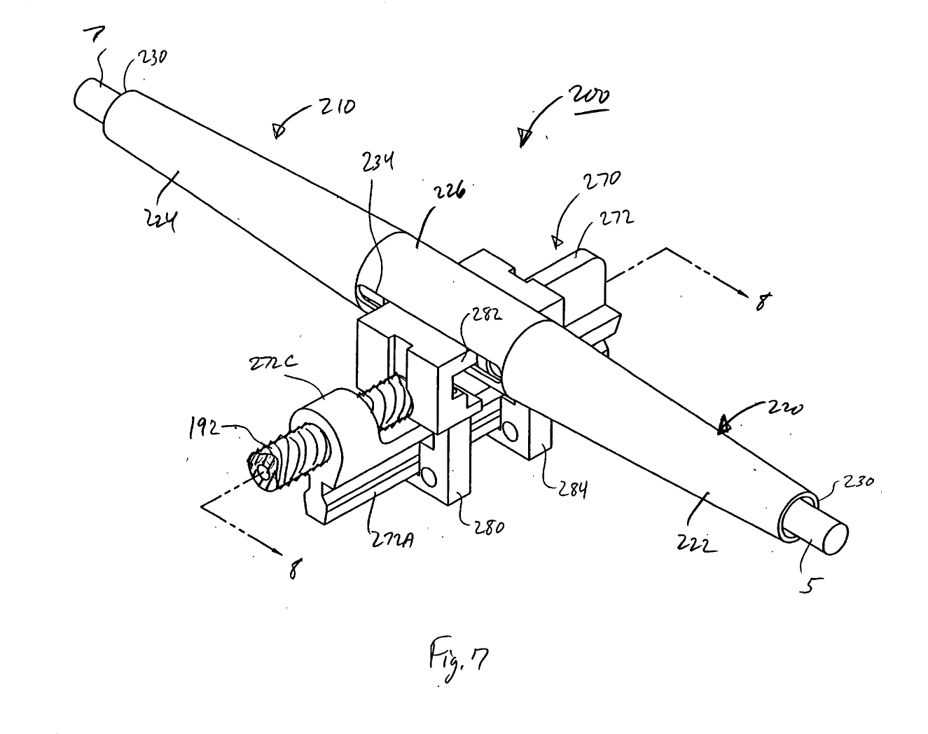

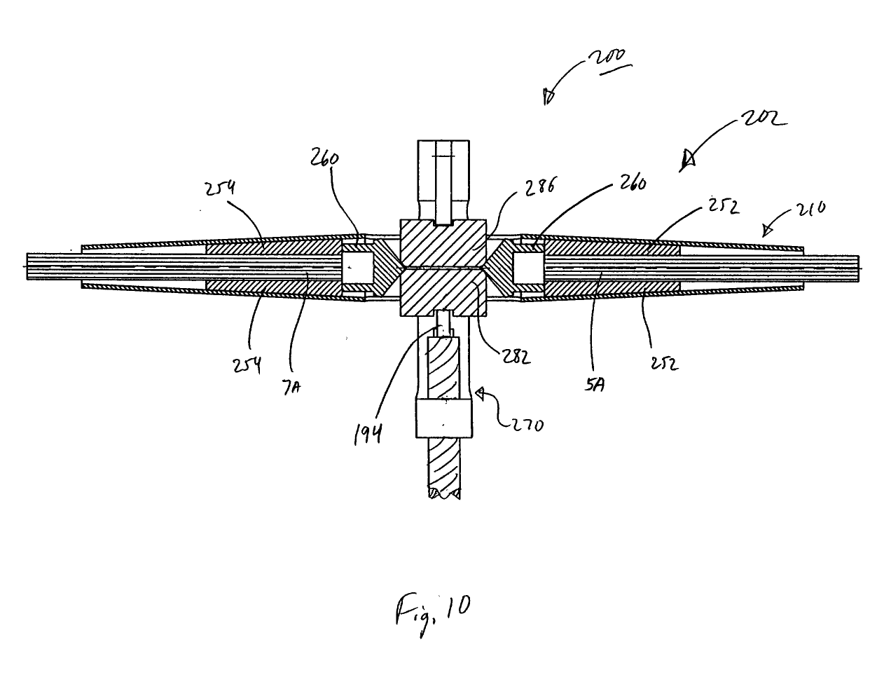

With reference to FIGS. 7-10, a connector system 200 according to further embodiments of the present invention is shown therein. The system 200 includes a connector 210 (FIG. 11) and an application tool 270 which may be used with the driver 190 or another suitable driver.

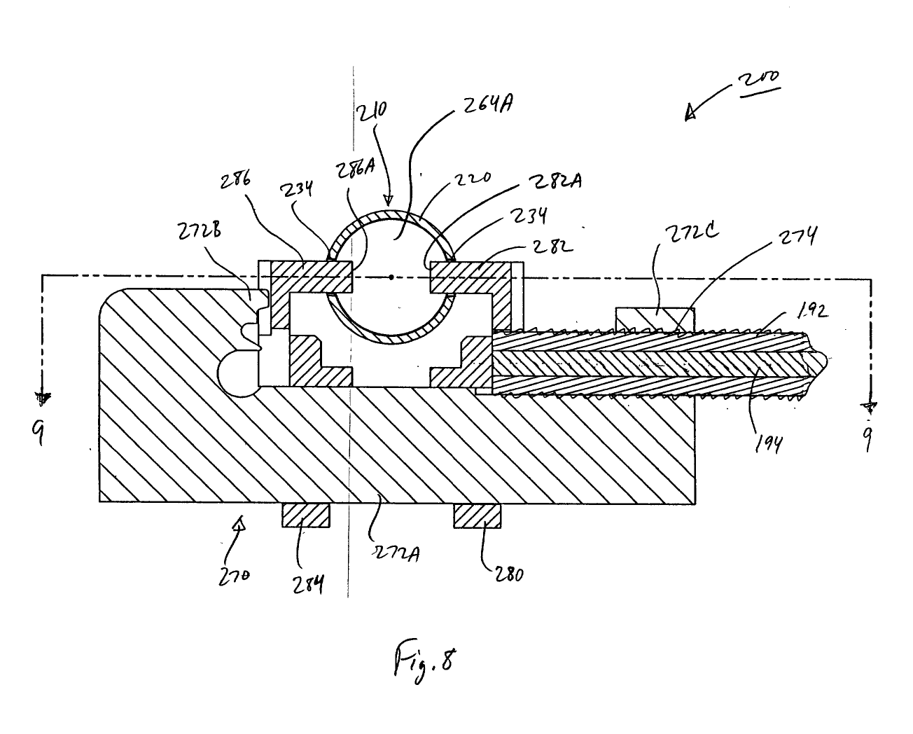

With reference to FIG. 11, the connector 210 includes a shell 220 having an inner surface 236. The inner surface 236 defines a connector passage 220A extending along a longitudinal connector axis B-B and fluidly communicating with opposed receiving openings 230. The shell 220 includes end portions 222, 224 defining tapered interior cavities 232 (FIG. 9) each forming a part of the passage 220A. The shell 220 also includes an intermediate portion 226 joining the end portions 222, 224. Axially extending, opposed slots 234 are formed in the shell 220 and communicate with the passage 220A. The shell 220 may be formed in the same manner and of the same materials as discussed above with regard to the shell 120.

A pair of jaw members 252 and a pair of jaw members 254 corresponding to the jaw members 152 and 154, respectively, are disposed in the cavities 232 in the same manner as described above with regard to the connector 110. The jaw members 252, 254 are configured in substantially the same manner as the jaw members 152, 154. The jaw members 252, 254 may be formed in the same manner and of the same materials as discussed above with regard to the jaw members 152, 154.

A pair of pistons 260 are mounted in the connector passage 220A between the sets of jaw members 252 and 254 as best seen in FIG. 9. Each piston 260 includes a body 262, a head 264 and a circumferential flange 266. Each body 262 has a body strike surface 262A and each head 264 has a conical head strike surface 264A. The body strike surfaces 262A of the respective pistons 260 are positioned adjacent the strike surfaces 252F, 254F of the jaw members 252, 254. The head strike surfaces 264A each face inwardly and are spaced apart from one another. The pistons 260 are preferably formed of metal, more preferably steel. The pistons 260 may be formed by machining or casting.

The application tool 270 comprises a body 272 including a rail 272A, an abutment portion 272B, and a driver mount portion 272C. A threaded bore 274 is formed in the driver mount portion 272C.

A pair of shuttles 280, 284 are mounted on the body 272 such that at least the shuttle 280 may slide along the rail 272A. The shuttles 280 and 284 include engagement arms 282 and 286, respectively. The engagement arms 282 and 286 include engagement surfaces 282A and 286A, respectively.

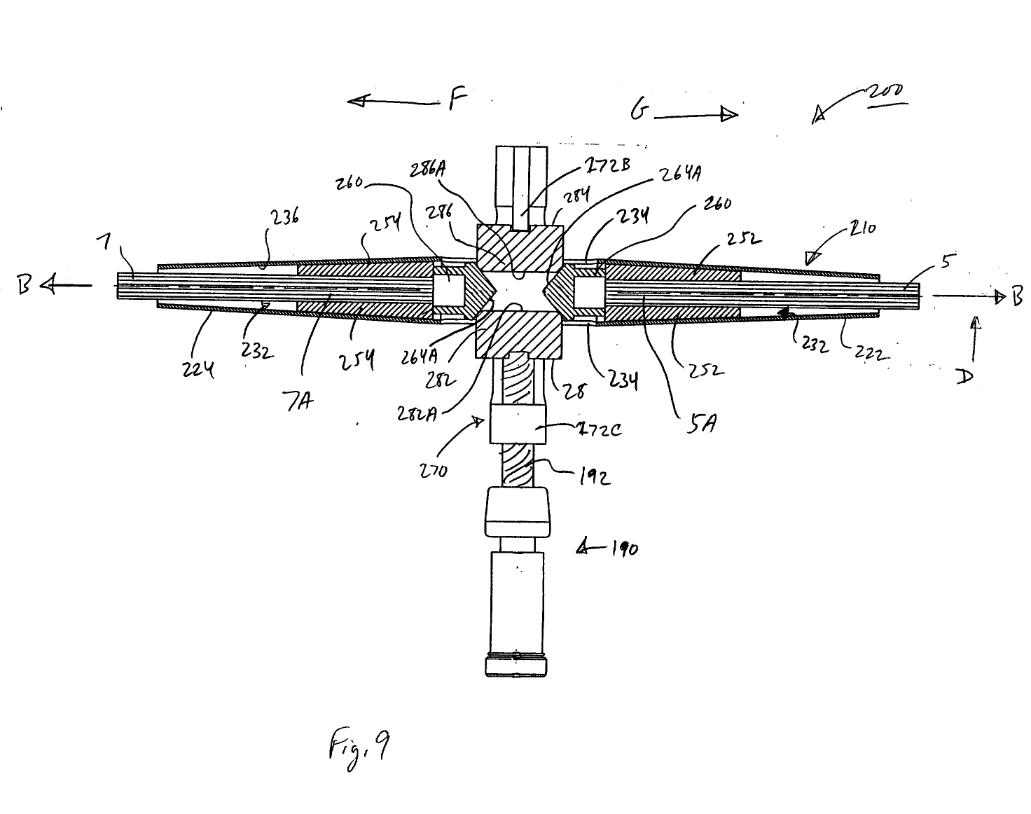

A splice 202 as shown in FIG. 10 may be formed in the following manner in accordance with method embodiments of the present invention. The cables 5 and 7 are inserted into the interior cavities 232 through respective ones of the receiving openings 230 such that cable portions 5A and 7A are received between respective ones of the pairs of jaw members 252 and 254. Before or after inserting the cables 5, 7 into the connector 210, the application tool 270 and the driver 190 are mounted on the connector 210 as shown in FIGS. 7-9 and the driver 190 is installed on the tool 270 as shown in FIG. 9.

Thereafter, the driver 190 is fired so that the piston 190 forces the shuttle 280 toward the shuttle 284 along the rail 272A in the direction D as shown in FIG. 9. The direction D is transverse to, and, preferably, perpendicular to, the connector axis B-B. The shuttle 284 is braced by the abutment portion 272B. As the engagement arms 282 and 286 are driven together, the strike surfaces 282A, 286A engage the ramped surfaces 264A of the pistons 260. The ramped surfaces 264A convert the transverse movement of the engagement arms 282, 286 to axial movement of the pistons 260. In this manner, the shuttles 280, 284 drive the pistons 260 in opposite directions F and G along the connector axis B-B. The pistons 260 in turn force the jaw members 252 and 254 outwardly along the axis B-B toward the adjacent receiving openings 230. As the jaw members 252 move down the shell portions 222, 224, the tapered profile of the engaging inner surface 236 forces the respective sets of jaw members 252, 254 to thereby compress onto the cable portions 5A, 7A and secure the cable portions 5A, 7A in the connector 210. Notably, the system 200 enables the user to capture both cable portions 5A, 7A with a single firing of the driver 190.

With the system 200 in the locked position as shown in FIG. 10, the tool 270 and the driver 190 are thereafter removed from the connector 210. If necessary, the shuttle 280 may be slid back away from the shuttle 284 such that the engagement arms 282, 286 may be removed from the slots 234. Upon removal of the tool 270, the splice 202 including the connector 210 and the cables 5, 7 remains.

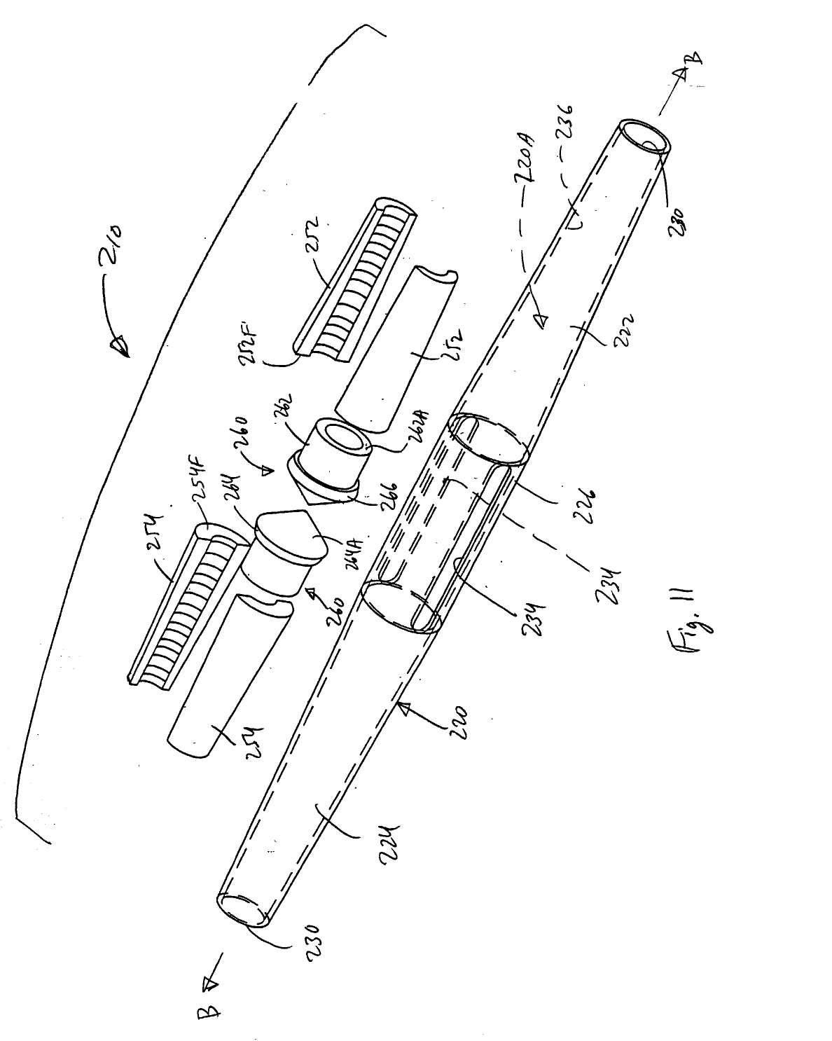

With reference to FIG. 12, a connector system 300 according to further embodiments of the invention is shown therein. The system 300 includes a connector 310 and corresponds to the system 100 except as follows. In place of the driver 190, a driver 390 is used. The driver 390 provides driving force to the engagement arm 382 using a screw-type mechanism rather than a propellant. More particularly, the driver 390 includes a rod 391 having a piston portion 394 and an externally threaded portion 395. The threaded portion 395 engages an internally threaded portion 393 such that rotation of the rod 391 is translated into linear movement along the connector axis. The rod 391 may be rotatively driven by, for example, a powered driver 398 engaging a head 397 of the rod 391. It will be appreciated that the driver 390 may be used in place of the driver 190 in the systems 100, 200.

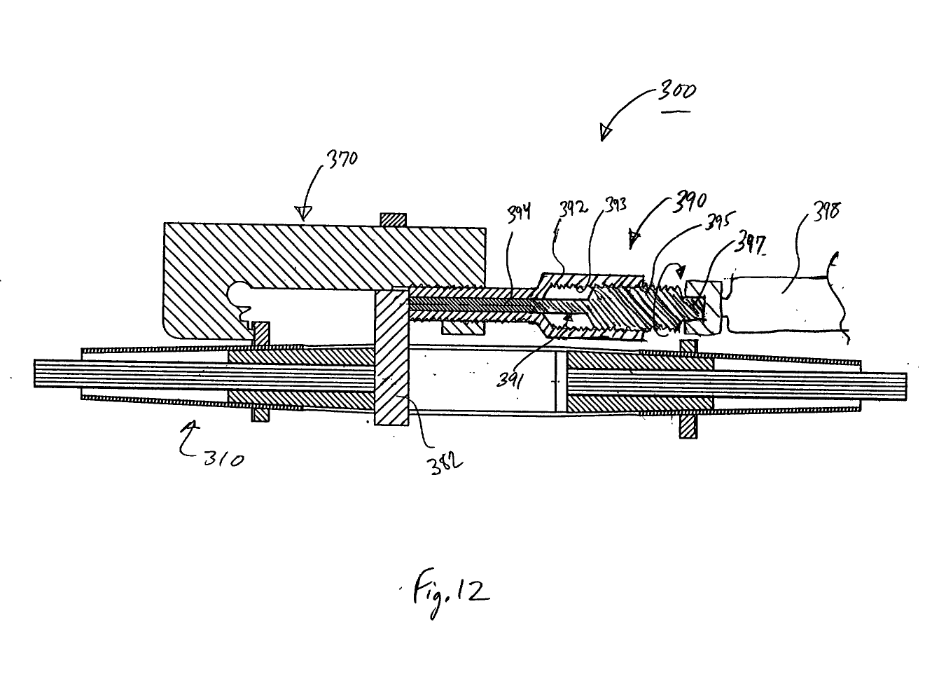

With reference to FIG. 13, a connector system 400 according to further embodiments of the present invention is shown therein. The system 400 includes a connector 410 and a suitable drive tool 490 operable to install the connector 410.

The connector 410 includes a shell 420 corresponding to the shell 120 except that only a single slot 434 is provided. The connector 410 has pairs of opposed jaw members 452, 454 corresponding to the pairs of jaw members 152, 154, respectively. The connector 410 also includes a pair of pistons 460 corresponding to the pistons 260, except that the end faces 464 of the pistons 460 are planar rather than conical.

The connector 410 further includes a pair of radially extending walls 471 disposed on either end of the slot 434 within the shell 420. The walls 471 are fixedly mounted relative to the shell 420. Each wall 471 has a threaded opening 473 formed therethrough.

A bolt member 491A, 491B is mounted in each opening 473. More particularly, an externally threaded portion 492 of each bolt member 491A, 491B is screwed into the respective opening 473 such that a head 496 (e.g., a hex head) of the bolt member 491A, 491B is accessible through the slot 434 and an opposing end of the bolt member 491A, 491B is disposed adjacent the piston face 464. Prior to installation, each bolt member 491A, 491B also has a weakened region 494 between its head 496 and the associated opening 473. In FIG. 13, the bolt member 491A is shown in a pre-installed condition and the bolt member 491B is shown installed.

The drive tool 490 includes a socket 499 adapted to receive the head 496. A suitable driver 498 is operable connected to the socket 499 to rotate the socket 499 as illustrated by the arrow. The driver 498 may be, for example, pneumatically, hydraulically or electrically powered, or may be a simple wrench or ratcheting mechanical wrench. It will be appreciated that while a hex head and socket are described and illustrated, other types of complementary configurations may be used for the head 496 and the socket 499. For example, the socket 499 may be replaced with a driver adapted for keyed insertion into a socket formed in the head 496.

The connector 410 may be used to form a splice connection, for example, in the following manner. With each of the bolt members 491A, 491B in a ready position (as illustrated by the bolt member 491A in FIG. 13), the end portions 5A, 7A of the cables 5, 7 are inserted between the respective pairs of jaw members 452, 454. Each bolt member 491A, 491B is then rotated to screw the bolt member 491A, 491B through the respective wall 471 and into engagement with the respective piston face 464. As each bolt member 491A, 491B is further rotated, it pushes the associated piston 460 and thereby the adjacent jaw members 452 or 454 toward the adjacent opening 430. In this manner, the end portions 5A, 7A are lockingly gripped by the associated jaws 452, 454 and the cables 5, 7 are secured to the connector 410 (as illustrated by the bolt member 491B, the jaw members 454 and the cable end portion 7A in FIG. 13).

According to particular embodiments of the present invention, once the desired amount of grip or load is attained between the jaw members 454, 454 and the end portions 5A, 7A, a corresponding amount of resistance to turning of the bolt member 491 is inherently provided by the illustrated arrangement. As the torque necessary to overcome this resistance is applied to the head 496, the weakened region 494 will break, leaving a break end 494A. In this manner, a prescribed and controlled amount of gripping force may be applied to the end portions 5A, 7A. Notably, this measured force may be applied without requiring special operations, tools or monitoring by an installer in the field. The break end 494A may also be resistant to tampering.

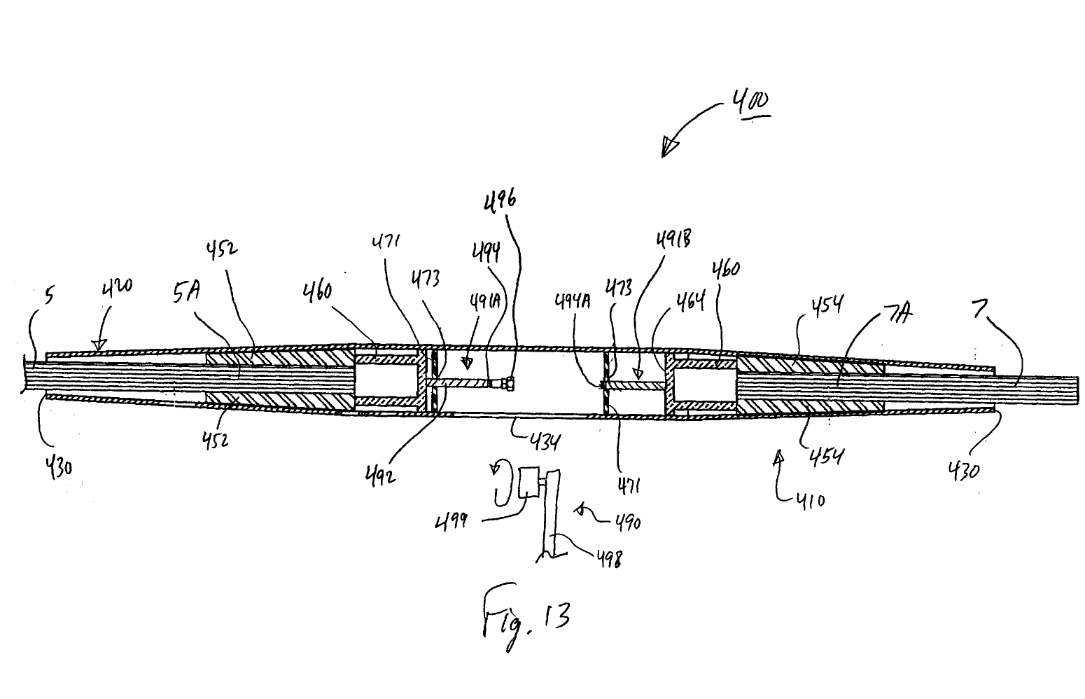

With reference to FIGS. 14-16 a connector system 500 and a connector 510 according to further embodiments of the invention are shown therein. The system 500 includes the connector 510, a tool 580 and a driver 590.

The connector 510 includes a shell 520 defining a connector passage or cavity 532. The shell 520 corresponds to the shell 120 except that opposed slots 534 are provided in place of the slots 134. Also, as illustrated, the shell 520 and the cavity 532 need not be tapered and are square in cross-section; however, it will be appreciated that other shapes may be used. The connector 510 defines a connector axis D-D (see FIG. 16).

A pin 540 extends transversely to the axis D-D and through the middle of the shell 520. The pin 540 is affixed to the shell 520, for example, by welding, interference fit, and/or suitable fasteners or retainers. A pair of opposed jaw members 550, 560 are mounted in the cavity 532 such that the pin 540 extends through respective bores 555, 565 of the jaw members 550, 560. The jaw members 550, 560 are able to slide up and down along the pin 540 and transversely to the connector axis D-D. However, the jaw members 550, 560 are prevented by the pin 540 from significant movement along the axis D-D with respect to the shell 520. The jaw member 550 includes jaw portions 552 and 554 on either side of the pin 540, and the jaw member 560 includes jaw portions 562 and 564 on either side of the pin 540.

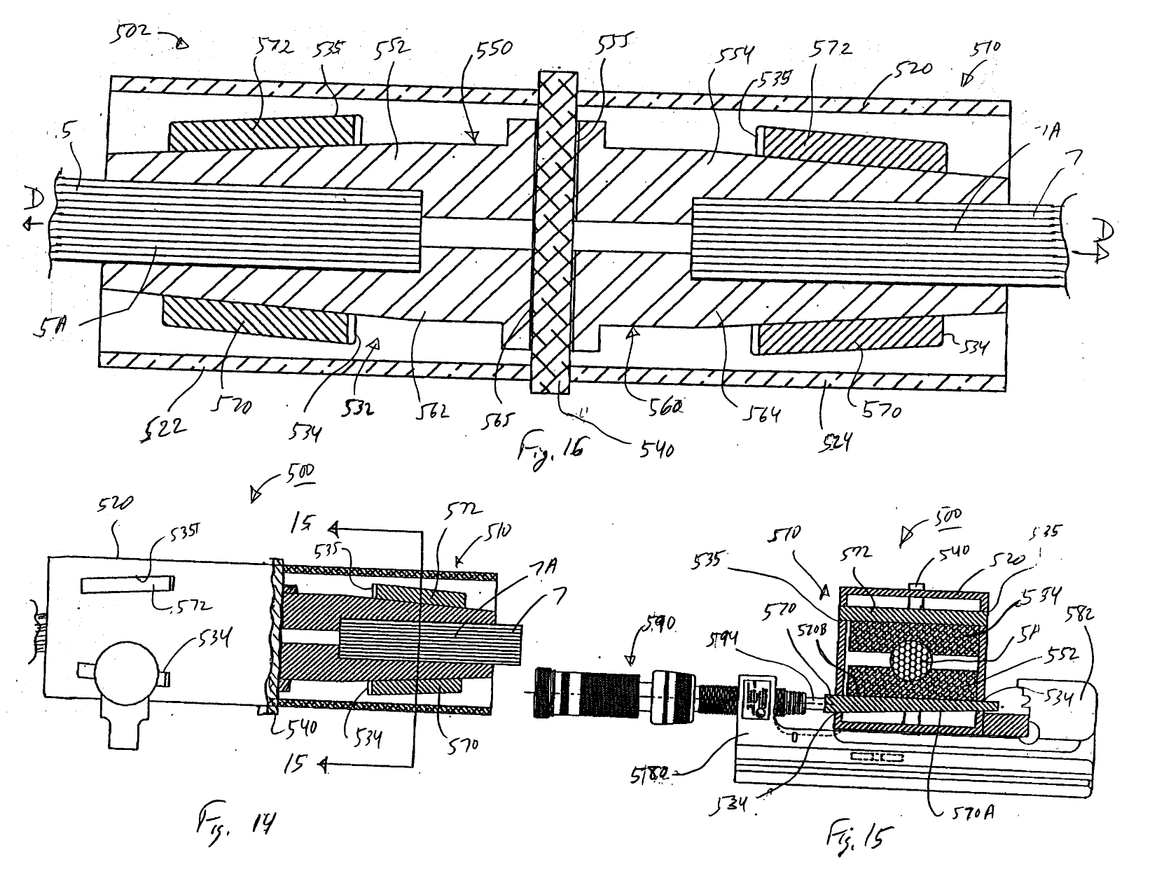

A pair of wedge members 570 and a pair of brace members 572 are adapted for insertion into the slots 534 and 535, respectively. The wedge members 570 each have a sloped surface 570A (FIG. 15) such that the sloped surface 570A and an opposing surface 570B form an angle therebetween. Preferably, the angle is between about 1.5 and 6 degrees. The wedge members 570 and the brace members 572 are preferably formed of aluminum alloy or copper alloy.

The system 500 may be used in the following manner to form a connection 502 as shown in FIG. 16. The end portion 5A of the cable 5 is inserted between the jaw portions 552, 562. The end portion 7A of the cable 7 is inserted between the jaw portions 554, 564. Before or after inserting the end portions 5A, 7A, the brace members 572 are inserted laterally through the respective pairs of opposed slots 535.

Thereafter, the wedge members 570 are inserted through the respective pairs of opposed slots 534 such that they are positioned between side wall portions 522, 524 of the shell 520 and the jaw portions 562, 564. In this manner, and as best appreciated from FIG. 15, the wedge members 570 force the jaw portions 562, 564 radially (with respect to the connector axis D-D) into engagement with the end portions 5A, 7A. Because the jaw portions 552, 554 are braced by the brace members 572, the jaw portions 552, 562 and the jaw portions 554, 564 cooperatively and securely grip the end portions 5A, 7A. The brace members 572 and the wedge members 570 remain installed in the shell 520 to securely retain the cables 5, 7. By selection of the dimensions of the wedge members 570, a prescribed and controlled amount of gripping force may be provided between the jaw portions 552, 554, 562, 564 and the end portions 5A, 7A.

The wedge members 570 are preferably driven into the connector 510 using the tool 580 and the driver 590. The driver 590 may be removably and reattachably mounted on the tool 580. The connector 510 is mounted in the tool 580 such that an abutment portion 582 of the tool 580 braces the shell 520. Each wedge member 570 is driven through the slots 534 by means of the driver 590 via a piston 594 as shown in FIGS. 14 and 15. The driver 590 may be a driver corresponding to the driver 190; however, other types of drivers may be employed such as a driver corresponding to the driver 390.

Various modifications to the connector 510 may be made. For example, the brace members 572 may also be wedge members having sloped surfaces. The brace members 572 may be omitted so that the jaw portions 552, 554 are braced by the upper wall of the shell 520 or are fixed with respect to the shell 520. Other shapes for the shell 520 may be used.

Using the foregoing connector systems and methods, a splice (e.g., splice 102, 202 or 502) or other connection may be conveniently and cost effectively formed. The drive tools and drivers (e.g., the drivers 190, 390, 490, 590) may be adapted to provide substantially more force than might be provided by hand or using conventionally employed hand tools.

Moreover, in various embodiments the tools and drivers may be adapted to provide a controlled, prescribed and consistent amount of force. In this manner, the characteristics of the electrical and mechanical joinder between the cable portions 5A, 7A and the connector 110, 210, 310, 410, 510 may be controlled to insure consistency and reliability. For example, by providing a prescribed amount of gunpowder or other propellant, a consistent and repeatable amount of force may be applied to the jaw members 152, 154 or 252, 254 so that a prescribed amount of grip is applied to the cable portions 5A, 7A.

Preferably, the jaw members 152, 154, 252, 254, 452, 454 are each driven a distance of between about 0.5 and 2.0 inches along the connector axis A-A or B-B. Preferably, the pairs of jaw members 152, 154, 252, 254, 452, 454 or jaw portions 552, 554, 562, 564 each apply a radially directed gripping force on the cable end portions 5A, 7A of between about 5,000 and 30,000 lbs.

While the connectors 110, 210, 410, 510 discussed above are adapted to form splices between cables, connectors and connector systems according to the present invention may be adapted to for other types of connections. For example, one end of the connector may incorporate the jaw members and be adapted to grip a cable using a tool and driver as discussed above, with the other end of the connector being a “dead end” adapted to mechanically and electrically engage a post or other contact structure by other means.

An electrically insulative cover may be wrapped about the splices 102, 202, 502 or other connections. While the connector shells 120, 220, 420, 520, as discussed above, are preferably formed of electrically conductive material and provide an electrical connection between the cables 5, 7, the shells 120, 220, 420, 520 may be formed of an electrically insulating material with other components being provided in the connector to provide electrical continuity between the cables 5,7.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. A connector for forming a connection with at least one electrically conductive cable using a mechanical tool having an engagement portion, the connector comprising:
a) a tubular shell having a connector axis and defining a receiving opening and an interior cavity communicating with the receiving opening, the receiving opening being adapted to receive the cable, wherein the interior cavity tapers inwardly along the connector axis toward the receiving opening; and
b) a jaw member disposed in the shell and adapted to grip the cable when the cable is disposed in the interior cavity and the jaw member is driven-along the connector axis toward the receiving opening;
c) wherein the connector is adapted to removably receive at least the engagement portion of the tool such that the tool may be used to forcibly drive the jaw member along the connector axis to grip the cable, the jaw member being configured to retain its grip on the cable upon removal of the engagement portion from the connector.

2. The connector of claim 1 wherein the connector is adapted to mechanically and electrically connect the cable to a second electrically conductive member.

3. The connector of claim 1 wherein the connector is adapted to receive and retain a high voltage cable having a diameter of between about 0.10 and 2.0 inches.

4. The connector of claim 1 wherein the shell is formed of an electrically conductive material.

5. The connector of claim 1 wherein the interior cavity is truncated conical.

6. The connector of claim 1 wherein the jaw member is tapered along the connector axis toward the receiving opening.

7. The connector of claim 1 including a second jaw member in the interior cavity and opposing the first jaw member, the first and second jaw members being adapted to cooperatively grip the cable, and wherein the connector is adapted to removably receive the engagement portion such that the tool may be used to forcibly drive the first and second jaw members along the connector axis to cooperatively grip the cable, the first and second jaw members being configured to retain their grip on the cable upon removal of the engagement portion from the connector.

8. The connector of claim 1 including at least one tool slot defined in the shell and adapted to receive the engagement portion.

9. The connector of claim 8 wherein the at least one tool slot includes first and second radially opposed tool slots defined in the shell, each adapted to receive the engagement portion.

10. The connector of claim 1 wherein the jaw member is adapted to be driven along the connector axis toward the receiving opening when the engagement portion of the tool is inserted in the connector and moved along the connector axis toward the receiving opening.

11. The connector of claim 1 wherein the jaw member is adapted to be driven along the connector axis toward the receiving opening when the engagement portion of the tool is inserted in the connector and moved transversely to the connector axis.

12. The connector of claim 11 including a radially ramped portion configured to engage the engagement portion and to convert the transverse movement of the engagement portion to axial movement of the jaw member.

13. The connector of claim 1 including a bracing structure affixed to the shell, wherein the bracing structure is adapted to engage an abutment portion of the tool to resist relative movement between the tool and the shell as the tool drives the jaw member.

14. The connector of claim 13 wherein the bracing structure includes a flange extending about at least a portion of a circumference of the shell.

15. The connector of claim 1 adapted to form a splice connection with a second electrically conductive cable, wherein:
a) the shell defines a second receiving opening and a second interior cavity communicating with the second receiving opening, the second receiving opening being adapted to receive the second cable, wherein the second interior cavity tapers inwardly along the connector axis toward the second receiving opening;
b) the connector further includes a second jaw member disposed in the shell and adapted to grip the second cable when the second cable is disposed in the interior cavity and the second jaw member is driven along the connector axis toward the second receiving opening; and
c) the connector is adapted to removably receive the engagement portion such that the tool may be used to forcibly drive the second jaw member along the connector axis to grip the second cable, the second jaw member being configured to retain its grip on the second cable upon removal of the engagement portion from the connector.

16. The connector of claim 15 including third and fourth jaw members in the first and second interior cavities, respectively, and opposing the first and second jaw members, respectively, the third and fourth jaw members being adapted to cooperatively grip the first and second cables with the first and second jaw members, respectively, and wherein the connector is adapted to receive the engagement portion such that the tool may be used to forcibly drive the first, second, third and fourth jaw members along the connector axis to grip the first and second cables, the first, second, third and fourth jaw members retaining their grips on the first and second cables upon removal of the engagement portion from the connector.

17. The connector of claim 15 wherein the first and second jaw members are adapted to be driven along the connector axis toward the first and second receiving openings, respectively, by a common movement of the tool.

18. The connector of claim 17 wherein each of the first and second jaw members are adapted to be driven along the connector axis toward the first and second receiving openings, respectively, when the engagement portion of the tool is inserted in the connector and moved transversely to the connector axis.

19. The connector of claim 1 including a bolt member having a threaded portion and a head, and wherein:
the threaded portion is mounted in the shell such that when the threaded portion is rotated relative to the shell the bolt member forcibly drives the jaw member along the connector axis to grip the cable; and
the head is adapted to engage the tool to transfer rotative drive force from the tool to the threaded portion.

20. The connector of claim 19 wherein the head is adapted to cease transferring the rotative drive force from the tool to the threaded portion after the jaw member grips the cable.

21. The connector of claim 20 wherein the head is adapted to break off from the threaded portion after the jaw member grips the cable.

22. The connector of claim 21 wherein the head is adapted to break off from the threaded portion when a prescribed gripping force is created between the jaw member and the cable.

23. A system for forming a connection with at least one electrically conductive cable, the system comprising:
a) a mechanical tool having an engagement portion; and
b) a connector including:
1) a tubular shell having a connector axis and defining a receiving opening and an interior cavity communicating with the receiving opening, the receiving opening being adapted to receive the cable, wherein the interior cavity tapers inwardly along the connector axis toward the receiving opening; and
2) a jaw member disposed in the shell and adapted to grip the cable when the cable is disposed in the interior cavity and the jaw member is driven along the connector axis toward the receiving opening;
c) wherein the connector is adapted to removably receive at least the engagement portion of the tool such that the tool may be used to forcibly drive the jaw member along the connector axis to grip the cable, the jaw member being configured to retain its grip on the cable upon removal of the engagement portion from the connector.

24. The system of claim 23 wherein the tool further includes a tool body and wherein the engagement portion is slidably mounted on the tool body.

25. The system of claim 23 wherein the tool is adapted to receive a force-generating device to drive the engagement portion along the tool body.

26. The system of claim 25 wherein the force-generating device includes an explosive propellant.

27. The system of claim 25 wherein the force-generating device includes a threaded member.

28. The system of claim 23 including at least one tool slot defined in the shell and adapted to receive the engagement portion.

29. The system of claim 28 wherein the at least one tool slot includes first and second radially opposed tool slots defined in the shell each adapted to receive the engagement portion.

30. The system of claim 23 wherein the tool is operable to drive the engagement portion and the jaw member along the connector axis toward the receiving opening to thereby force the jaw member to grip the cable in the interior cavity.

31. The system of claim 23 wherein the tool is operable to drive the engagement portion transversely to the connector axis to force the jaw member along the connector axis toward the receiving opening to grip the cable in the interior cavity.

32. The system of claim 31 wherein the connector includes a radially ramped portion configured to engage the engagement portion and to convert the transverse movement of the engagement portion to axial movement of the jaw member.

33. The system of claim 23 wherein:
the connector includes a bracing structure affixed to the shell; and
the tool includes an abutment portion adapted to engage the bracing structure to resist relative movement between the tool and the shell as the tool drives the jaw member.

34. The system of claim 23 adapted to form a splice connection with a second electrically conductive cable, wherein:
a) the shell defines a second receiving opening and a second interior cavity communicating with the second receiving opening, the second receiving opening being adapted to receive the second cable, wherein the second interior cavity tapers inwardly along the connector axis toward the second receiving opening;
b) the connector further includes a second jaw member disposed in the shell and adapted to grip the second cable when the second cable is disposed in the interior cavity and the second jaw member is driven along the connector axis toward the second receiving opening; and
c) the connector is adapted to removably receive the engagement portion such that the tool may be used to forcibly drive the second jaw member along the connector axis to grip the second cable, the second jaw member being configured to retain its grip on the second cable upon removal of the engagement portion from the connector.

35. The system of claim 34 wherein connector and the tool are configured such that the first and second jaw members can be driven along the connector axis toward the first and second receiving openings, respectively, by a common movement of the engagement portion.

36. The system of claim 35 wherein the connector and the tool are configured such that the first and second jaw members can be driven along the connector axis toward the first and second receiving openings, respectively, by inserting the engagement portion into the connector and moving the engagement portion transversely to the connector axis.

37. The system of claim 23 wherein the connector includes a bolt member having a threaded portion and a head, and wherein:
the threaded portion is mounted in the shell such that when the threaded portion is rotated relative to the shell the bolt member forcibly drives the jaw member along the connector axis to grip the cable; and
the head is adapted to engage the tool to transfer rotative drive force from the tool to the threaded portion.

38. The system of claim 37 wherein the head is adapted to cease transferring the rotative drive force from the tool to the threaded portion after the jaw member grips the cable.

39. The system of claim 38 wherein the head is adapted to break off from the threaded portion after the jaw member grips the cable.

40. The system of claim 39 wherein the head is adapted to break off from the threaded portion when a prescribed gripping force is created between the jaw member and the cable.

41. A method for forming a connection between a connector and a cable, the connector including a tubular shell having a connector axis and defining a receiving opening and an interior cavity communicating with the receiving opening, wherein the interior cavity tapers inwardly along the connector axis toward the receiving opening, the connector further including a jaw member disposed in the shell, the method comprising:
a) inserting the cable through the receiving opening and into the interior cavity;
b) inserting an engagement portion of a mechanical tool into the connector;
c) using the tool via the engagement portion to drive the jaw member along the connector axis toward the receiving opening such that the jaw member grips the cable; and thereafter
d) removing the engagement portion from the connector.

42. The method of claim 41 wherein using the tool via the engagement portion to drive the jaw member includes driving the engagement portion and the jaw member along the connector axis toward the receiving opening to thereby force the jaw member to grip the cable in the interior cavity.

43. The method of claim 41 wherein using the tool via the engagement portion to drive the jaw member includes driving the engagement portion transversely to the connector axis to force the jaw member along the connector axis toward the receiving opening to grip the cable in the interior cavity.

44. The method of claim 43 wherein using the tool via the engagement portion to drive the jaw member includes engaging a radially ramped portion of the connector with the engagement portion to convert the transverse movement of the engagement portion to axial movement of the jaw member.

45. The method of claim 41 wherein using the tool via the engagement portion to drive the jaw member includes driving the engagement portion using a force-generating device to drive the engagement portion.

46. The method of claim 45 wherein driving the engagement portion using a force-generating device includes exploding a propellant.

47. The method of claim 45 wherein driving the engagement portion includes rotating a threaded member of a force-generating device.

48. The method of claim 41 further comprising attaching the force-generating device to the tool prior to using the tool via the engagement portion to drive the jaw member and detaching the force-generating device from the tool subsequent to using the tool via the engagement portion to drive the jaw member.

49. The method of claim 41 further including mounting the connector on a tool body of the tool and inserting the engagement portion into the connector through a slot in the shell prior to using the tool via the engagement portion to drive the jaw member.

50. The method of claim 41 further including mounting the connector on a tool body of the tool such that an abutment portion of the tool engages a bracing portion of the connector, wherein the engagement between the bracing structure and the abutment portion resists relative movement between the tool and the shell as the tool drives the jaw member.

51. The method of claim 41 wherein the shell defines a second receiving opening and a second interior cavity communicating with the second receiving opening, the second interior cavity tapering inwardly along the connector axis toward the second receiving opening, and the connector further includes a second jaw member disposed in the shell, the method further comprising:
a) inserting a second electrically conductive cable through the second receiving opening and into the second interior cavity; and
b) using the tool via the engagement portion to drive the second jaw member along the connector axis toward the second receiving opening such that the second jaw member grips the second cable.

52. The method of claim 51 wherein using the tool via the engagement portion to drive the first jaw member and using the tool via the engagement portion to drive the second jaw member include driving the first and second jaw members along the connector axis toward the first and second receiving openings, respectively, using a common movement of the engagement portion.

53. The method of claim 52 wherein driving the first and second jaw members includes moving the engagement portion transversely to the connector axis.

54. The method of claim 41 wherein the connector includes a bolt member having a threaded portion and a head, the method further comprising:
engaging the head with the tool;
forcibly rotating the threaded portion via the head using the tool such that the bolt member forcibly drives the jaw member along the connector axis to grip the cable and the head ceases transferring rotative drive force from the tool to the threaded portion after the jaw member grips the cable.

55. The method of claim 54 wherein forcibly rotating the threaded portion includes breaking the head off of the threaded portion after the jaw member grips the cable to cease transferring rotative drive force from the tool to the threaded portion.

56. A connector for forming a connection with at least one electrically conductive cable using a mechanical tool, the connector comprising:
a) a tubular shell including a side wall and having a connector axis, the shell defining a wedge slot in the side wall, a receiving opening adapted to receive the cable, and an interior cavity communicating with the receiving opening and adapted to receive an end portion of the cable such that the end portion extends along the connector axis;
b) a jaw member disposed in the shell and adapted to grip the end portion in the interior cavity; and
c) a wedge member adapted to be inserted through the wedge slot and into the interior cavity between the jaw member and the side wall to force the jaw member radially into engagement with the end portion.

57. The connector of claim 56 wherein the shell is formed of an electrically conductive material.

58. The connector of claim 56 further including a second jaw member in the interior cavity and opposing the first jaw member, the first and second jaw members being adapted to cooperatively grip the cable.

59. The connector of claim 58 further including a second wedge slot defined in the side wall and a second wedge member adapted to be inserted through the second wedge slot and into the interior cavity between the second jaw member and the side wall to force the jaw member radially into engagement with the end portion in opposition to the first jaw member.

60. The connector of claim 56 adapted to form a splice connection with a second electrically conductive cable, wherein:
a) the shell defines a second wedge slot in the side wall, a second receiving opening and a second interior cavity communicating with the second receiving opening, the second receiving opening being adapted to receive a second end portion of the second cable such that the second end portion extends along the connector axis;
b) the connector further includes a second jaw member disposed in the shell and adapted to grip the second end portion in the second interior cavity; and
c) a second wedge member adapted to be inserted through the second wedge slot and into the second interior cavity between the second jaw member and the side wall to force the second jaw member radially into engagement with the second end portion.

61. A system for forming a connection with at least one electrically conductive cable, the system comprising:
a) a connector including:
1) a tubular shell including a side wall and having a connector axis, the shell defining a wedge slot in the side wall, a receiving opening adapted to receive the cable, and an interior cavity communicating with the receiving opening and adapted to receive an end portion of the cable such that the end portion extends along the connector axis;
2) a jaw member disposed in the shell and adapted to grip the end portion in the interior cavity; and
3) a wedge member adapted to be inserted through the wedge slot and into the interior cavity between the jaw member and the side wall to force the jaw member radially into engagement with the end portion; and
b) a mechanical tool adapted to forcibly drive the wedge member into the interior cavity between the jaw member and the side wall.

62. The system of claim 61 wherein the tool further includes a tool body adapted to hold the shell.

63. The system of claim 61 wherein the tool is adapted to receive a force-generating device to drive the wedge member into the wedge slot.

64. The system of claim 63 wherein the force-generating device includes an explosive propellant.

65. The system of claim 63 wherein the force-generating device includes a threaded member.

66. The system of claim 61 wherein:
the connector further includes a second wedge member and a second jaw member, the second jaw member disposed in the interior cavity and opposing the first jaw member, the first and second jaw members being adapted to cooperatively grip the cable; and
the mechanical tool is adapted to forcibly drive the second wedge member into the interior cavity between the second jaw member and the side wall.

67. The system of claim 66 further including a second wedge slot defined in the side wall and a second wedge member adapted to be inserted through the second wedge slot and into the interior cavity between the second jaw member and the side wall to force the jaw member radially into engagement with the end portion in opposition to the first jaw member.

68. The system of claim 61 adapted to form a splice connection with a second electrically conductive cable, wherein:
a) the shell defines a second wedge slot in the side wall, a second receiving opening and a second interior cavity communicating with the second receiving opening, the second receiving opening being adapted to receive a second end portion of the second cable such that the second end portion extends along the connector axis;
b) the connector further includes a second jaw member disposed in the shell and adapted to grip the second end portion in the second interior cavity; and
c) a second wedge member adapted to be inserted through the second wedge slot and into the second interior cavity between the second jaw member and the side wall to force the second jaw member radially into engagement with the second end portion;
d) wherein the mechanical tool is adapted to forcibly drive the second wedge member into the second interior cavity between the second jaw member and the side wall.

69. A method for forming a connection between a connector and a cable, the connector including a tubular shell and a jaw member disposed in the shell, the shell including a side wall and having a connector axis, the shell defining a wedge slot in the side wall, a receiving opening, and an interior cavity communicating with the receiving opening, the method comprising:
a) inserting an end portion of the cable through the receiving opening and into the interior cavity; and
b) inserting a wedge member through the wedge slot and into the interior cavity between the jaw member and the side wall to force the jaw member radially into engagement with the end portion.

70. The method of claim 69 wherein inserting the wedge member includes using a tool to drive the wedge member into the interior cavity between the jaw member and the side wall.

71. The method of claim 70 further including mounting the connector on the tool such that an abutment portion of the tool resists relative movement between the tool and the shell as the tool drives the wedge member.

72. The method of claim 70 wherein using a tool to drive the wedge member includes using a force-generating device to drive the wedge member into the interior cavity between the jaw member and the side wall.

73. The method of claim 72 wherein using a force-generating device to drive the wedge member includes exploding a propellant.

74. The method of claim 72 wherein using a force-generating device to drive the wedge member includes rotating a threaded member.

75. The method of claim 72 further comprising attaching the force-generating device to the tool and detaching the force-generating device from the tool.

76. The method of claim 69 wherein the shell defines a second wedge slot in the side wall, a second receiving opening and a second interior cavity communicating with the second receiving opening, and the connector further includes a second jaw member disposed in the shell, and further including:
a) inserting a second end portion of a second cable through the second receiving opening and into the second interior cavity; and
b) inserting a second wedge member through the second wedge slot and into the second interior cavity between the second jaw member and the side wall to force the second jaw member radially into engagement with the second end portion.
